(19) United States
(12) Patent Application Publication
(10) Pub. No.: US 2005/0240430 A1
(43) Pub. Date: Oct. 27, 2005

(54) Management system for a business enterprise

(76) Inventor: Jason Baum, Pearland, TX (US)

Correspondence Address: Robert M. Tuttle, 907 Tennyson Drive, Pearland, TX, 77584, US

(21) Appl. No.: 11/114,736

(22) Filed: Apr. 26, 2005

Related U.S. Application Data
(60) Provisional application No. 60/565,333, filed on Apr. 26, 2004.

(51) Int. Cl. G06F 17/60

(52) U.S. Cl. 705/1

(57) ABSTRACT

Emergency situations can be difficult to manage in any business enterprise. Embodiments of the invention are directed to systems and methods that allow a business enterprise, such as a petrochemical plant, hospital, or high rise building, to manage information regarding an emergency situation. This management system is preferably capable of providing customized evacuation reports to various individuals throughout the business enterprise. Such customized evacuation reports may be useful, for example, in a petrochemical plant when weather conditions change rapidly rendering previous evacuation plans hazardous. Further, these customized reports also may be useful in predicting the location of various individuals within the business enterprise, which may be a difficult task in an emergency situation.

### CROSS REFERENCE TO RELATED APPLICATIONS

This application claims priority to a provisional patent application Ser. No. 60/565,333 filed on Apr. 26, 2004.

### BACKGROUND

On Wednesday, Mar. 23, 2005, a terrible accident happened at a 1,200 acre oil refinery in Texas City, Tex.—the third largest refinery in the United States. A refinery of this size typically employs around 1,800 individuals (including employees and contractors). The accident occurred as a result of a fire in a piece of plant equipment that was being restarted after a two week shut down for maintenance purposes. Ultimately, the accident resulted in the death of a total of 15 people and injured more than 100 others. The troubling part about this accident, and others like it, is that some of the dead were discovered during clean up efforts, and prior to this, they were believed to be outside the plant during the explosion. Unfortunately, accidents such as this are not uncommon in the petrochemical industry, and therefore other accidents of this type may continue to occur.

Because of the very nature of petrochemical plants, evacuation in the event of an emergency explosion may be particularly difficult for many reasons. For example, subsequent explosions may occur as a result of the first explosion. Additionally, hazardous fumes may be released during any of these explosions. In order to avoid evacuating toward these hazardous fumes, individuals within the plant usually exit the area by paying close attention to wind socks. In some of the larger plants, however, the danger associated with emergency situations may be more complicated. For example, in a larger plant, a siren may sound indicating an emergency leak in a petrochemical tank. Individuals working in the plant may be unaware of the details of this emergency, however, and simply evacuate the plant to a predetermined location according to a standard emergency action plan. In some scenarios, however, the predetermined location may be unsafe, for example, it may be downwind from the emergency leak and therefore pose a potential health hazard because of hazardous fumes.

Accordingly, methods and systems that address these and other problems are desirable.

### SUMMARY

Embodiments of the invention are directed to systems and methods that allow a business enterprise, such as a petrochemical plant, hospital, or high rise building, to manage information regarding an emergency situation. This management system is preferably capable of providing customized evacuation reports to various individuals throughout the business enterprise. Such customized evacuation reports may be useful, for example, in a petrochemical plant when weather conditions change rapidly rendering previous evacuation plans hazardous. Further, these customized reports also may be useful in predicting the location of various individuals within the business enterprise, which may be a difficult task in an emergency situation.

### BRIEF DESCRIPTION OF DRAWINGS

The detailed description of exemplary embodiments of the invention will reference the accompanying drawings, in which like components are indicated using like reference numerals:

FIG. 1 illustrates one embodiment of a management system capable of being implemented in business enterprise;

FIG. 2 illustrates exemplary broadcast channels that may be used by the business enterprise;

FIG. 3 illustrates another embodiment of a management system capable of being implemented in a business enterprise;

FIGS. 4A-B illustrate exemplary algorithms that may be executed by various embodiments of the invention;

FIGS. 5A-B illustrates exemplary functions that may be implemented in at least some embodiments of the invention; and

FIG. 6 illustrates yet another embodiment of a management system capable of being implemented by a business enterprise.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the invention are directed to systems and methods that allow a business enterprise, such as a petrochemical plant, hospital, or high rise building, to manage information regarding an emergency situation. This management system is preferably capable of providing customized evacuation reports to various individuals throughout the business enterprise. Such customized evaluation reports may be useful, for example, in a petrochemical plant when weather conditions change rapidly rendering previous evacuation plans hazardous. Further, these customized reports also may be useful in predicting the location of various individuals within the business enterprise, which may be a difficult task in an emergency situation.

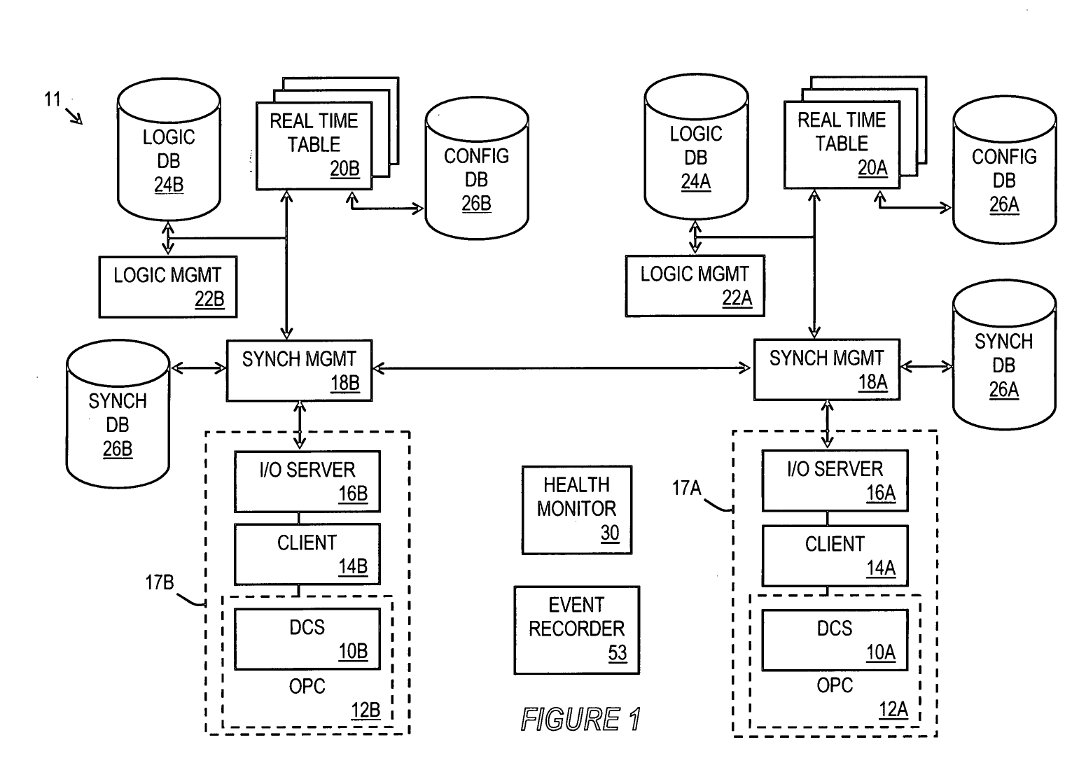

FIG. 1 depicts an exemplary management system that may be used in a business enterprise 11. Referring now to FIG. 1, a distributed control system (DCS) 10A performs various operations associated with business enterprise 11. Industry providers for DCS 10A include Honeywell, Foxboro, Invensys, Siemens, Emerson, Yokogawa and ABB.

Generally speaking, a DCS preferably includes several programmable logic controllers (PLCs) networked to each other, but also may be as simple as one PLC remotely connected to a single computer. Each PLC within a DCS may be used to monitor and control equipment located in physically separate locations within the business enterprise. Further, each PLC within a DCS may be dedicated to a single process within a business enterprise. Depending on the business enterprise, these processes may or may not be related. For example, in a waste water treatment facility these processes are probably related, whereas in a manufacturing facility these processes are probably not related.

Physically, a DCS may include both wireless and hardwired systems that exist within the physical boundaries of the business enterprise. Regardless of the physical implementation of a DCS, each constituent PLC preferably is capable of operating autonomously by storing enough information to operate independent of the other PLCs. For example, in a petrochemical plant, if an explosion occurs in one area of the plant destroying one PLC that controls a valve, another PLC in a different location controlling a compressor preferably will be able to function.

As indicated in FIG. 1, DCS 10A may have an object linking and embedding (OLE) process control server (OPC) 12A layered on top of DCS 10A. Briefly put, OPC 12A is an industry standard interface allowing the exchange of data between industrial controllers and other distributed control systems as described in pages 1-16 of “OPC Overview” version 1.0, dated Oct. 27, 1998, which is incorporated by reference as if reproduced in full below. Alternative industry standards of exchanging data between industrial controllers, such as Modbus®, may also be implemented.

Referring still to FIG. 1, a client 14A is coupled to OPC 12A. Client 14A may physically exist in a location remote from OPC 12A and DCS 10A. Client 14A runs application programs that interface with OPC 12A. By using OPC 12A, the application programs run by client 14A need not know the specific details of the communication protocol. This allows the clients and servers within business enterprise 11 to be manufactured by different vendors. As discussed above, the specific coupling between the various components of business enterprise 11 may include wired Ethernet or wireless protocols.

During operation, application programs running on client 14A exchange data with OPC 12A. Client 14A is further coupled to an I/O server 16A. I/O server 16A receives data from client 14A and distributes the received data to other portions of business enterprise 11 as discussed in more detail below. DCS 10A, OPC 12A, client 14A, and I/O server 16A comprise a management system 17A that may be replicated and implemented at various locations within a business enterprise 11 (illustrated as management systems 17A-B in FIG. 1).

The various management systems 17A-B may be coupled to synchronization managers 18A-B. Management systems 17A-B may be formed with a personal computer (PC), where the connection to the synchronization managers 18A-B occurs via the PC's various communication ports (universal serial bus (USB), network, serial, parallel, wireless, etc.) Systems 17A-B preferably communicate with each other through synchronization managers 18A-B, although communication through other components are also possible, or direct communication without synchronization managers 18A-B is also possible.

In some embodiments, system 17B may be remotely located and therefore may not have connection to other systems within the business enterprise 11. This scenario may arise, for example, if business enterprise 11 is a petrochemical processing plant where client 14A is an evacuation management system that is responsible for evacuating plant personnel and system 17B is an alert system in a remote location, such as an auditory or visual alert system. In this scenario, communication may take place between the various synchronization managers 18A-B.

Synchronization managers 18A-B may relate various forms of data and synchronize the components of the evacuation management system. For example, I/O server 16A may receive date information and relay this information to the synchronization manager 18A, which in turn relays this information to system 17B. Synchronization manager 18A is coupled to a real time data table 20A.

Real time data tables 20A are storage locations that may be a collection of numerous variables and data types. The physical embodiment of real time data tables 20A may take many forms, such as a hard disk, random access memory (RAM), or tape backup. Data types in real time data tables 20A may include Boolean, string, real, as well as other variables types. Table 1 below illustrates exemplary contents of a real time data table 20A implemented in a petrochemical plant. As can be appreciated from Table 1, real time data tables 20A may include information for each individual within the business enterprise. Particularly, this information may include the location of each individual, the location of the emergency, and the overall weather conditions. Such information may be especially useful in the case of a complex business enterprise (e.g., in a 1,200 acre petrochemical plant or a 75 story office building.)

TABLE 1

| | | Wind | Location of | Location of |
|---|---|---|---|---|
| Individual | Wind Speed | Direction | Emergency | individual |
| Bob Neilson | 7 m.p.h. | East | Sector 2 | Sector 10 |
| Ed Partridge | 2 m.p.h. | North | Sector 2 | Sector 7 |

Real time data table 20A preferably is coupled to logic management 22A, which is further coupled to a logic database 24A. Logic management 22A preferably is capable of executing algorithms or code stored in logic database 24A. For example, in some embodiments, logic management 22A may be a microprocessor (such as an Intel Pentium processor) capable of executing code stored on a hard disk type storage. Regardless of the actual implementation, the code executed by logic management 22A may entail comparing the data stored in real time data table 20A with predetermined hazardous scenarios stored in logic database 24A.

Logic management 22A preferably scans real time data tables 20A looking for predetermined conditions. For example, in an evacuation management system of a petrochemical plant, the data in real time data tables 20A may represent measurements such as wind speed and direction, location of an emergency event, and location of all personnel as depicted in Table 1. In this scenario, logic management 22A may perform predetermined operations (such as determining if individual evacuation plans for each person or group of people in the business enterprise 11) on the information in the real time data table 20A and send the appropriate data to various portions of the evacuation management system through the synchronization manager 18A. For example, if logic management 22A determines that one portion of a business enterprise 11 is inadvertently releasing hazardous gases, then logic management 22A may direct the appropriate warning messages and other indicia to personnel in and around that portion of the business enterprise 11. Other, distinct messages could be sent to other personnel throughout the facility and within the community at large.

Logic management 22A and real time data tables 20A preferably communicate bi-directionally. Logic management 22B has connections akin to logic management 22A. Since synchronization managers 18A-B are capable of communicating with each other, logic management 22B may access I/O server 16A, client 14A, and DCS 10A in addition to similar blocks contained within system 17B.

Preferably, each synchronization manager 18A-B in business enterprise 11 is coupled to a real time data table 20A-B as well as an I/O server 16A-B. Real time data tables 20A-B and logic databases 24A-B further couple to logic management 22A, either directly or through a synchronization manager.

In this manner, logic management 22A-B may perform the function of a truth table, where its logic functions are performed on the real time data stored in real time data tables 20A-B. As logic databases 24A-B are updated (e.g., by the synchronization managers 18A-B), each logic management 22A-B may update itself. Such an update may occur as the result of new equipment being added to the business enterprise, and therefore, each predetermined hazardous scenario also may need to be updated.

Although bi-directional communication between logic databases 24A-B and logic management 22A-B is possible, logic databases 24A-B preferably pushes data out to logic management 22A-B and logic management 22A-B may pull data from logic database 24A-B as desired. The connection between logic management 22A-B and logic databases 24A-B may be intermittent or continuous.

Logic database 24A may be a “master-type” database to logic database 24B or alternatively it could be a “peer-to-peer” arrangement. Thus, logic database 24A may communicate with synchronization manager 18A to send messages that logic database 24B should update itself. In this manner, each synchronization manager 18A-B as well as each logic database 24A-B, logic management 22A-B, and real time data tables 20A-B may operate independently. For example, if system 17A were destroyed in an explosion, the remaining system 17B could operate independently. In this manner, if DCS 10A is destroyed, the remaining portions of the system may collaborate to determine which of them has the most pertinent or up-to-date information, and the system may decide a replacement for DCS 10A and OPC 12A, such as the similarly situated components of system 17B.

A business enterprise 11 may contain redundant sensors on various equipment. For example, a compressor located within business enterprise 11 may include multiple sensors to monitor compressor vibration and eventual compressor failure to provide redundancy. Generally these sensors are located in close proximity to each other such that if a portion of the business enterprise 11 is destroyed, it is highly likely that both sensors will be destroyed and redundancy is destroyed also. Since systems 17A and system 17B may be located in separate areas of the business enterprise 11, however, if DCS 10A and OPC 12A are destroyed due to explosion, it is unlikely that the similarly situated DCS and OPC of system 17B will also be destroyed. Thus, overall redundancy may be improved by implementing systems 17A-B and allowing them to operate independent of each other.

In some embodiments, logic database 24A-B, logic management 22A-B, and real time data tables 20A-B are integrated in a single PLC. The PLC may be recording real time data, like the temperature and pressure behavior with respect to time. This temperature and pressure behavior may be stored in the real time data tables 20A-B. Logic management 22A-B may be pre-loaded with predetermined operations from logic database 24A-B. For example, logic management 22A-B may check certain fields in real time data tables 20A-B to check the status of a compressor within business enterprise 11. If the logic management 22A-B determines that unsafe temperature or pressure levels exist at the compressor in question, then flow rates may be adjusted or emergency evacuation procedures may be implemented. Since logic database 24A-B, logic management 22A-B, and real time data tables 20A-B may be integrated in a PLC, this operation may be invisible to ordinary personnel. In yet other embodiments, logic database 24A-B, logic management 22A-B, and real time data tables 20A-B may be implemented using human machine interface (HMI) or man machine interface (MMI) software provided by vendors such as Wonderware, Iconics, and Cimplicity.

Real time data tables 20A-B are coupled to a configuration data bases 26A-B. As is the case with logic databases 24A-B, configuration databases 26A-B may be files stored in a storage location such as a hard drive. Configuration databases 26A-B may include mapping to the different I/O servers 16A-B. This mapping information then may be used by synchronization managers 18A-B in determining where to send synchronization information.

Configuration databases 26A-B may tag measurements located in real time data tables 20A-B. For example, a measurement may be tagged as “temperature reading number 1”, along with mapping information of how to get this tagged measurement to the particular I/O server 16A-B. The tag may further include the measurement's data type and units (e.g., ° C. or ° F.). In some embodiments, the tag includes a time stamp to indicate the time that the measurements were taken.

Logic management 22A may reference the temperature reading by its tag, “temperature reading number 1”, and check to see if measurement in this tag goes over a certain temperature threshold. Configuration databases 26A-B are coupled to the synchronization managers 18A-B, and therefore the various configuration databases along with their tagged contents may be synchronized among the business enterprise 11.

In addition to the aforementioned components, some embodiments of the invention include a health monitor 30. Health monitor 30 may monitor each portion of the business enterprise, the communication channels, and the databases. Health monitor 30 then may create log files for each component in the system. In the case of a petrochemical plant, health monitor 30 may be used after an explosion has occurred to determine the cause of the explosion. In order to determine that each component in business enterprise 11 is operating properly, health monitor 30 may periodically establish communication with and check on each device in business enterprise 11. For example, health monitor 30 may consult I/O server 16 to run a self test and report if it is functioning properly.

Clients 14A-B may have internal monitoring software or hardware that produces a reading to be used by health monitor 30, and this reading may indicate data flow rate, (i.e., data per second). Such a reading also may indicate that clients 14A-B are functioning properly. Health monitor 30 may monitor these readings without processing them.

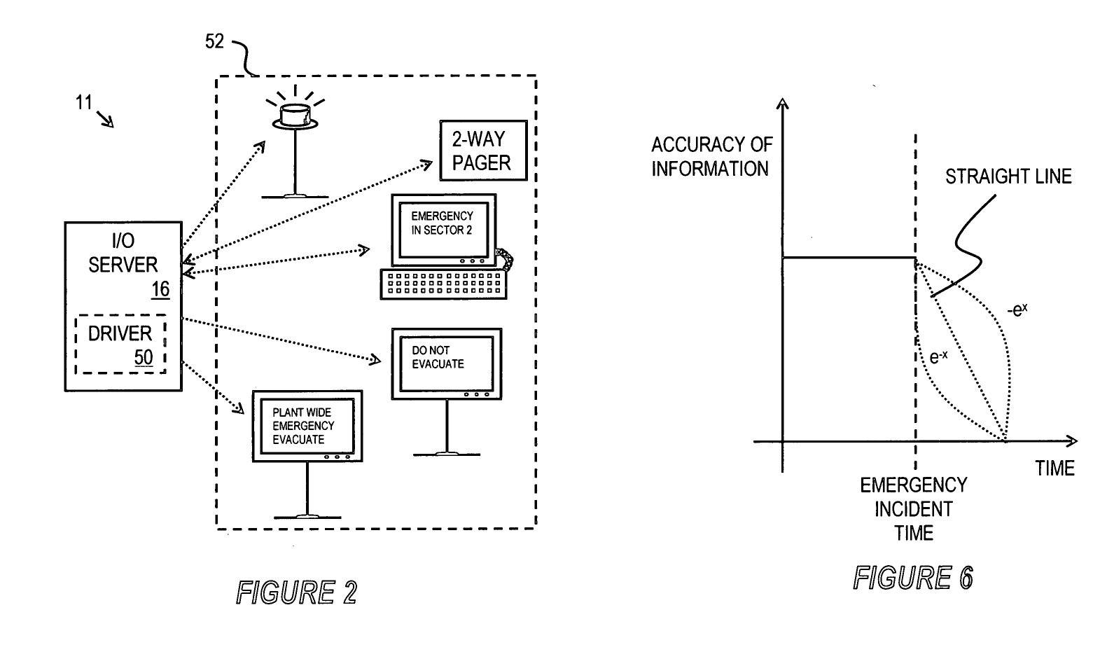

As shown in FIG. 2, I/O servers 16A-B may communicate data to a driver 50, which is capable of delivering information to various channels 52. Different locations within the business enterprise 11 may have separate channels 52. Accordingly, a “channel” refers to anything capable of conveying a message to personnel located within the business enterprise 11. For instance, as illustrated in FIG. 2, a light on a pole that indicates an emergency condition may be a channel. In this scenario, driver 50 may be a driver capable of making lights flash. Additionally, in other embodiments, channel 52 may be a PC at the workstation of clerical personnel in the business enterprise 11. Since personnel located inside buildings of business enterprise 11 may not be aware of potential hazardous conditions that exist outside of the building, a message on their computer screen may be especially useful (i.e., channel 52 is a PC screen in this case). Likewise, channel 52 may represent an email sent to user.

Another possible channel 52 may be an electronic sign that dynamically displays data. Examples of suitable channels may include a light emitting diode (LED) sign or a plasma display. These signs may be located at different locations within the business enterprise 11 and may be one of the ways that personnel are instructed as to what to do. The various signs may contain different messages based on their location. For example, if business enterprise 11 is a petrochemical plant, hazardous conditions may exist in one area of the plant and yet no hazardous conditions may be present in another area of the plant. Accordingly, displays located in an affected area may be instructing personnel to evacuate whereas other displays that are not located in an affected area may be instructing the personnel not to evacuate. In this manner, personnel in different areas of the business enterprise 11 receive customized messages based on things such as their current location, environmental factors, and operational status of the business enterprise 11.

Further, another potential channel is a 2-way pager. In some embodiments, a custom evacuation plan may be relayed to this pager, and the individual may acknowledge the custom evacuation plan as discussed in detail below with regard to FIG. 7.

Thus, if the logic management 22A-B determines that a condition is met it may send the message to a proper I/O server 16A-B to effectuate a message on a display.

For example, personnel in one area may be instructed to go Northeast to point B immediately, whereas personnel in this other area to go Southwest and go to a primary evacuation area. Meanwhile, personnel located in an office building may not be in danger and will be told to remain in their position. Each of these messages may be determined by the logic management 22A-B, which may make decisions based on environmental conditions such as wind speed, temperature of various components within the business enterprise 11.

In addition to the aforementioned operation, business enterprise 11 may include a manual over-ride for an administrator. This may include a user manually monitoring conditions within the business enterprise 11, possibly by monitoring a PC. In such a scenario, prior to each decision by logic management 22A-B to activate a channel 52, the user would approve of such a decision. This manual intervention may be dynamic such as a hazardous situation is occurring, or may be done at a later time. In any case, the messages sent to the user by logic management 22A-B may by prioritized by the level of potential hazardous condition. The user may choose to send the message as intended by the logic management 22A-B prior to displaying on the channel 52 or the user may choose to send an edited version of the message to the channel 52. For example, if a first message communicates that a temperature within the business enterprise 11 is higher than normal, a certain level message (e.g., a level 3 message) may be generated by the logic management 22A-B, and this level 3 message may be overridden by the user. If, however, a second message communicates that the temperature is at extremely high levels indicating possible explosion, then a higher level message (e.g., a level 1 message) may be generated by the logic management 22A-B, and this message may replace the first message, or be sent directly to the channels 52 without intervention by the user. The prioritization of the messages may be modified at any time.

A history of the messages directed to the channels 52, as well as the messages that are not sent to the channels 52 may be recorded. This history may be arranged chronologically, according to level, and may be color coded for ease of interpretation by a later user. Currently displayed messages will be shown and also messages that were overridden as well as the reason why the user overrode the message.

Referring back to FIG. 1, business enterprise preferably includes an event recorder 53. Event recorder 53 maintains the different states of the various components within the business enterprise 11 at different times. This may prove particularly useful in determining the root cause of a hazardous condition after the situation has occurred.

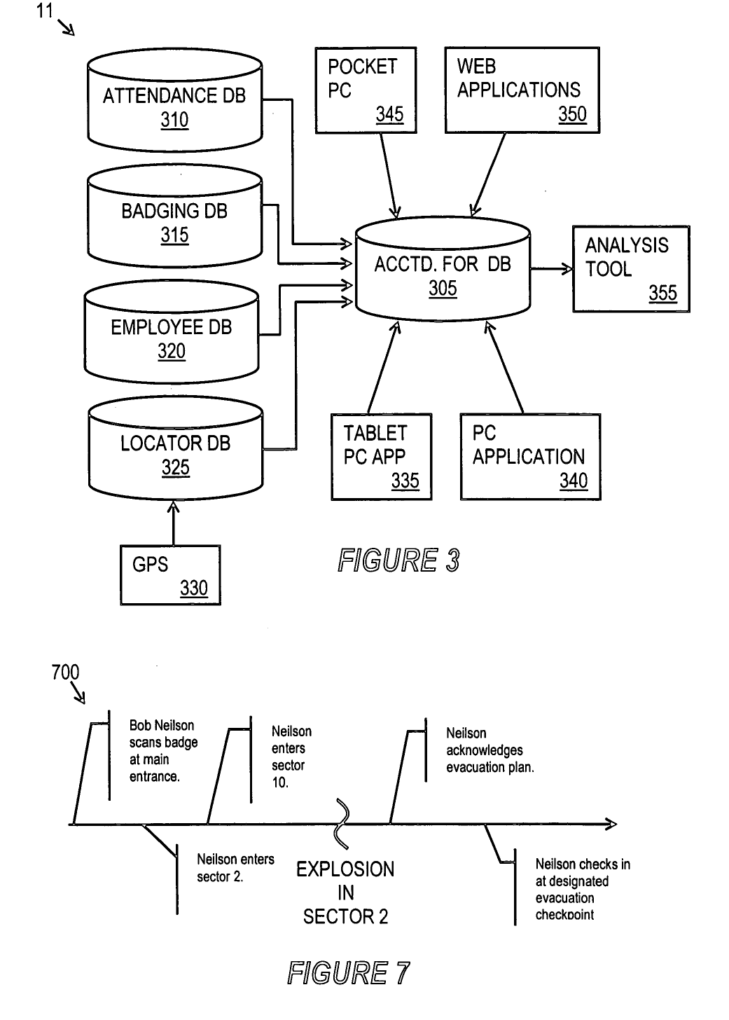

FIG. 3 represents a block diagram of an exemplary tracking system 300 in accordance with at least one embodiment of the invention. Such a tracking system may assist in determining the location of various individuals within business enterprise 11 in the event of an emergency.

Referring now to FIG. 3, tracking system 300 includes an accounted for database (AFD) 305 that is coupled to multiple other databases 310-325. Attendance database 310 preferably includes data concerning all of the individuals that have been present in business enterprise 11 within a predetermined period of time. For example, attendance database 310 may include a list of all individuals, employees and contractors, which have been present at business enterprise 11 within the past 30 days. Badging database 315 preferably includes data indicating the individuals that have scanned their badges at a security checkpoint before entering and leaving a business enterprise 11. Employee database 320 preferably includes data indicating the employees that are assigned to business enterprise 11 as well as their supervisors. Additionally, a locator database 325 may indicate the most recent location of various individuals within business enterprise 11, as well as location histories for individuals, which may be useful in predicting where a missing individual is located. Information in locator database 325 may be provided from a global positioning system (GPS) 330 worn by each individual while in the business enterprise.

Ultimately, AFD 305 may include a list of all possible individuals that may be present in business enterprise 11 in the event of an emergency situation. This list of individuals may be updated with information from applications running on various peripheral devices such as a tablet PC 335, a stand alone PC 340, a pocket PC 345, or a web application 350. An analysis tool 355 preferably is coupled to AFD 305 and may be implemented in either hardware or software. In this manner, analysis tool 355 may be running on any of the peripheral devices such as tablet PC 335, a stand alone PC 340, a pocket PC 345, or a web application 350.

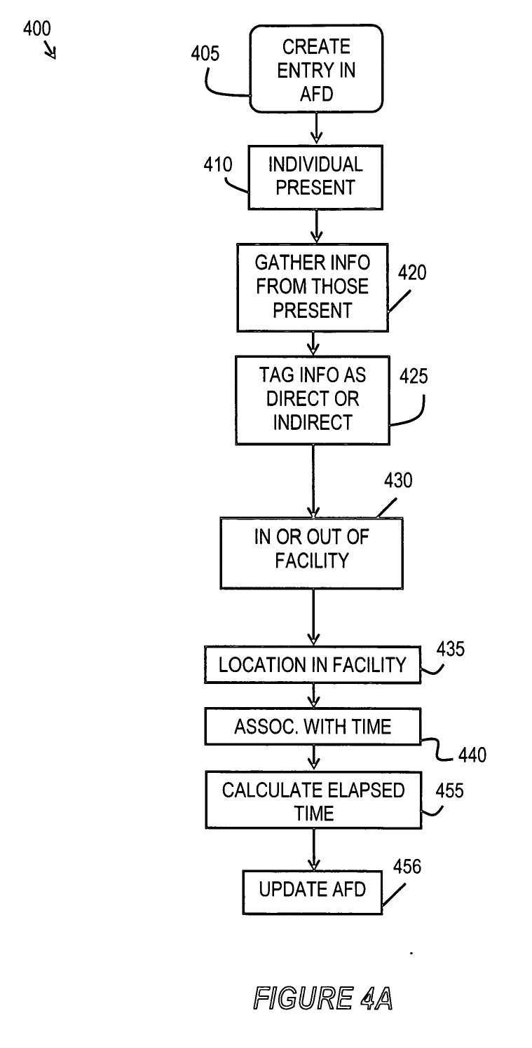

FIGS. 4A-B represents exemplary algorithms 400-401 that may be implemented the system shown in FIG. 3. More particularly, algorithm 400 is a gathering algorithm that may be performed in business enterprise 11, whereas algorithm 401 is an analysis algorithm that may be performed by analysis tool 355. The amount of time between the execution of gathering algorithm 400 and the analysis algorithm 401 may be several days or weeks, or in some embodiments, they may be executed simultaneously.

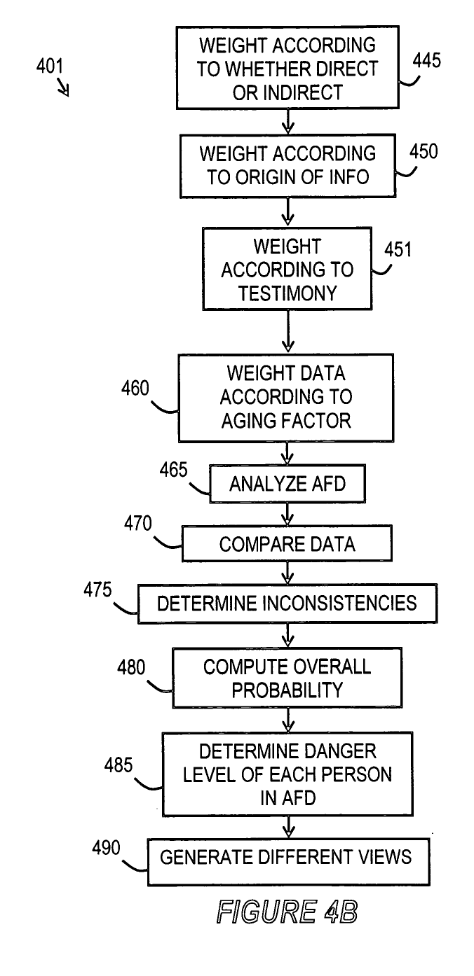

Algorithms 400-401 may be useful in the event of an emergency situation to track individuals within business enterprise 11 and determine which of these individuals are in danger, and which are not. FIGS. 5A and 5B illustrate exemplary forms 500 and 505 respectively from analysis tool 355. Entry form 500 may be organized to indicate a particular group 502, (e.g., the maintenance group) that may have been working in business facility 11 at the time of the emergency situation.

Referring now to FIGS. 4A-B and 5A-B, algorithm 400 includes searching databases 310-325 to create an entry into AFD 305 for each individual per block 405. In due course, the entries created in block 405 may be part of a list 510 of individuals including employees and contractors who may be at risk from an emergency situation arising in business enterprise 11.

In block 410, analysis tool 355 may process the data in AFD 305 to determine if an individual is present at an evacuation checkpoint. An individual may be determined to be present through a variety of scenarios. For example, badging database 315 may indicate that an employee scanned their badge at an evacuation checkpoint. Further, during a role call at the evacuation check point, an individual's supervisor may indicate their presence in pocket PC 345, which may then be relayed to analysis tool 355 that may be running on pocket PC 345. Regardless of how the employee is determined to be present, once an employee is determined to be present, AFD 305 may be updated to reflect their presence as indicated in block 456. Entry form 500 preferably reflects whether the individuals in list 510 are present through presence entry field 515.

If an individual in list 510 is not present at the evacuation checkpoint then information may be gathered from those who are present as indicated in block 420. Such information may be entered into form 505 by accessing information entry field 520. For example, if analysis tool 355 is running on a pocket PC 345 the user may click on information entry field 520 for a particular individual in list 510 who is not present to bring up entry form 505 so that further information may be entered regarding the missing individual.

Once entry form 505 is launched, the individual reporting the information may enter their name into name field 525. Next, the information being entered into form 505 may be characterized as either direct or indirect, per block 425 of algorithm 400. Referring briefly back to FIG. 1, this characterization may occur by tagging the information in real time data tables 20A-B. For example, information may be tagged as direct if the individual reporting the information had personal knowledge of the information, whereas if the individual reporting only heard about the information then it may be classified as indirect.

Referring again to FIGS. 4A and 5A-B, the individual reporting the information in form 505 may indicate whether they saw (i.e., direct), knew (i.e., indirect), or heard (i.e., indirect) the information on the missing individual. As illustrated in block 430 of algorithm 400, an individual reporting information into entry form 505 may indicate whether the missing individual was either in or out of the facility. If the missing individual was in the facility then the individual reporting the information may enter this location in location field 530, per block 435 of algorithm 400.

Regardless of whether the missing individual was in or out of the facility, the individual reporting this information preferably also indicates the time associated with information in entry form 505 by filling out time entry field 535, per block 440 of algorithm 400. As was described above, in some embodiments, information in AFD 305 does not come from entry forms 500 and 505 but rather from databases 310-325. Databases 310-325 also may associate a time or time stamp their information, per block 440. Regardless of whether an actual person associates a time in 535 or whether a database time stamps the information in AFD 305, this time stamp preferably will be used to “age” the data as described more fully below. In addition, the “time” associated with the information in block 440 may be a variety of times that each may be pertinent during the analysis algorithm 401. For example, the times may include: an event time, or time that the individual reporting actually saw the information happen; a report time, or time when the individual actually makes the report; an incident time, or time that the emergency incident occurs; and an analysis time, or time that analysis algorithm 401 actually occurs. Each of these times may be determined during either the gathering algorithm 400 or during the analysis algorithm 401.

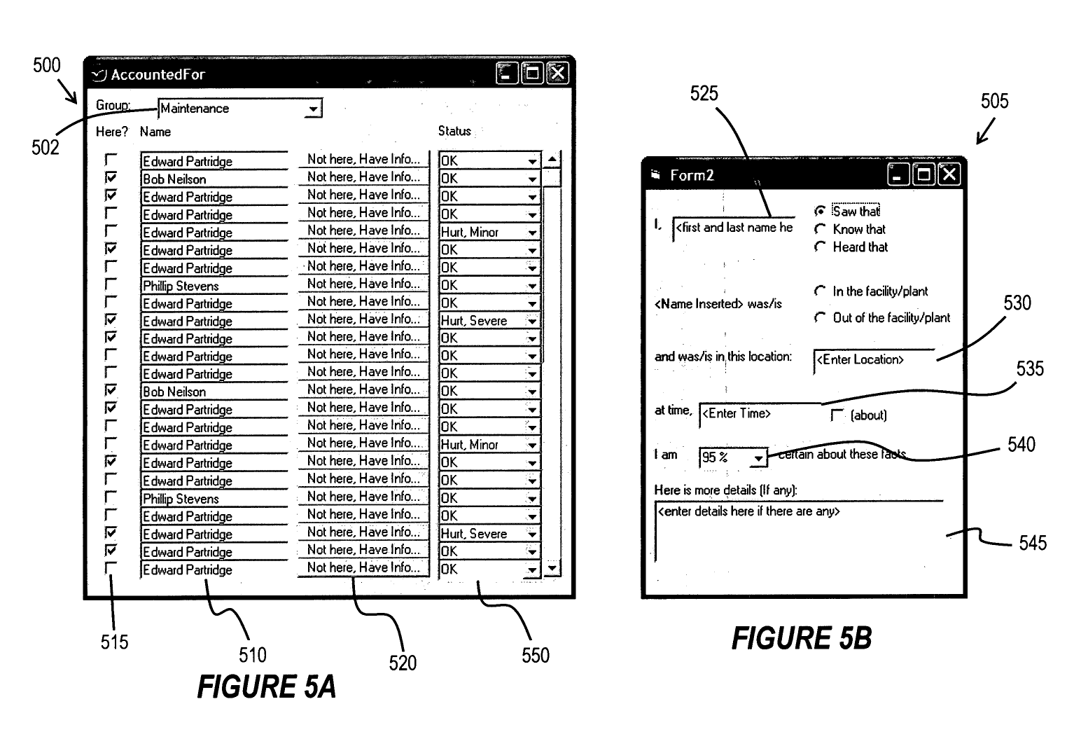

Further, the elapsed time between two or more of these time periods may be calculated in block 455. Such a calculation may be performed, for example, by taking the difference between the time stamp on the information in AFD 305 and the current time, which may be derived from GPS 330. Once the elapsed time is calculated, the information in AFD 305 may be weighted according to how old the information is as is illustrated in algorithm 401 and FIG. 6, which depicts exemplary aging functions that may be used to weight the information in AFD 305 per algorithm 401.

The individual reporting also may assess their own level of certainty of the information contained in entry form 505 by filling out in certainty field 540. Further, the individual reporting the information may also give additional facts in detail field 545, which may be later used by emergency personnel in locating missing individuals. For example, if the individual reporting has personal knowledge that the missing individual is not in danger, then this information may be reflected in detail field 545. A status field 550 indicating the health of individuals in list 510 may be updated at any time while entry forms 500 and 505 are being filled out.

Once the information regarding a missing individual is entered into entry forms 500 and 505, this information is weighted statistically according to various criteria as illustrated in algorithm 401 of FIG. 4B. In block 445, analysis tool 355 may weight the information according to how direct the information is. For example, as noted in FIG. 5B, if the individual reporting actually saw the missing individual in a certain location within the business enterprise 11 at a certain time, then analysis tool 355 may assign an accuracy rating, of say 70%, to this information. If, on the other hand, the individual reporting only heard that the missing individual was in a certain location at a certain time, for example, via a radio communication, then analysis tool 355 may assign a much lower accuracy rating, of say 20%, to this information.

Likewise, in block 450, the information in AFD 305 may be weighted depending on whether the information came from a person or an automated database. For example, locator database 325, which may note the location of individuals within a business enterprise 11 using GPS 330, represents such an automated database. Generally, the automated databases represent more reliable sources of information and therefore the information coming from an automated database may have a higher level of accuracy associated it than information coming from a person.

Similarly, in block 451, the information in AFD 305 may be weighted based on an assessment by the individual reporting the information. For example, the person reporting the information may feel that they are less than 50% confident in the accuracy of their testimony.

Referring to FIG. 6, a time line is illustrated on the abscissa axis and the accuracy of the information with respect to time is illustrated on the ordinate axis. As time progresses from the emergency event the accuracy of information in AFD 305 may deteriorate. As represented in FIG. 6, this deterioration may take many forms. For example, the deteriorating accuracy may be a straight line deterioration, a stair-case deterioration (not specifically shown in FIG. 6), or exponentially deteriorating accuracy. Note, however, that depending on the source of the information in AFD 305, each piece of information in AFD 305 may follow different aging functions. Regardless of the aging function used, however, data is preferably weighted according to an aging factor in block 460.

Once the information in AFD 305 is gathered, the contents of AFD 305 may be analyzed, per block 465, to determine if there is inconsistent information per blocks 470 and 475. For example, information from entry forms 500 and 505 may indicate that a missing individual is in a certain location within business enterprise 11, whereas locator database 325 may indicate that the missing individual left several hours ago. In this scenario, the overall probability associated with each inconsistent outcome may be calculated in block 480, for example, by multiplying the probabilities associated with weighting functions 445, 450, 451, and 460.

Next, in block 485, the potential level of danger for each individual within AFD 305 may be determined. This level of danger may be determined by assigning the most pessimistic overall probability to missing individuals. That is, if a majority of information in AFD 305 indicates that there is a chance that a missing individual is still located near the scene of an explosion, then the missing individual may be assigned a higher level of danger than a missing individual that is believed to have left the business enterprise shortly after the explosion. With AFD 305 updated to reflect information from the various sources, different views may be generated per block 490. For example, in some embodiments, a time line view may be generated depicting the location of a missing individual before, during, and after the emergency situation. FIG. 7 illustrates an exemplary timeline 700 for a hypothetical employee described in Table 1.

Referring now to FIG. 7 and Table 1, hypothetical employee Bob Neilson may begin the workday by scanning his badge at the main entrance to business enterprise 11. Badging database 315 may reflect this information, and relay this information to AFD 305. Neilson may be an employee, in which case employee database 320 may include a record for him; in this scenario AFD 305 may rely on employee database 320 in creating an entry for Neilson per block 405 of algorithm 400. Likewise, Neilson may be a contractor and may have been working in business enterprise 11 for the past 30 days; in this scenario AFD 305 may rely on attendance database 310 to create an entry for Neilson per block 405.

Referring still to FIG. 7 and Table 1, Neilson later may move to a different area of business enterprise 11, say, for example, sector 2. This information may reside in locator database 325 and may be based on a GPS 330 that Neilson is wearing. If the hypothetical sector 2 is a building, GPS 330 may not be able to indicate Neilson's movements within the building, since global positioning systems are generally incapable of operating within closed buildings. Thus, if Neilson were to move to a different area within business enterprise 11, say, for example hypothetical sector 10, this movement may go unnoticed by locator database 325. Neilson's movement may be recorded, however, in badging database 315 as Neilson scans his badge at sector 10.

When an explosion occurs in sector 2, badging database 315 and locator database 325 may contain conflicting information. This conflicting information, however, may be time stamped (e.g., by real time data tables 20A-B) so that analysis tool 355 can digest the conflicting information, compute the probability of Neilson being located in the conflicting locations, and customize an evacuation route based on the weather conditions from Table 1. This information may be relayed to Neilson on via a communication channel 52, such a pager. Neilson's custom evacuation plan, generated by logic management 22A-B, may include details on how to avoid a potentially hazardous gas cloud, or may indicate that the closest evacuation checkpoint in sector 10 is unsafe, for example due to the potential for a subsequent explosion, and give Neilson an alternative evacuation plan. Neilson may acknowledge this plan, and his acknowledgment may be recorded in AFD 305, for example, via Neilson's 2-way pager. This acknowledgement may be logged in AFD 305, so that if for some reason Neilson turns up missing, analysis tool 355 may be able to predict where Neilson was last recorded to be and where he was headed. Such a utility may be invaluable in times of emergency when decisions regarding saving an individual need to be made in a relatively short period of time based on the totality of the information available. Likewise, if Neilson checks in at his designated checkpoint, then AFD 305 may log this as well so that rescue efforts may be more properly directed to those individuals still located within a dangerous area. Views akin to timeline 700 may be generated, per block 490, for any individual within AFD 305.

While the focus of this disclosure has been with regard to petrochemical facilities, the various embodiments of the invention are equally applicable to other industries as well. For example, the weather related information may come from an internet based information source. Additionally, algorithm 401 may include dialing a predetermined phone number or phone based service that broadcasts the customized evacuation plans. Also, the embodiments disclosed may find application in hospital evacuation situations, the national amber alert system for tracking missing children, and high rise office building emergency evacuations, which are just a few of the applications that may benefit from this invention.

1. An emergency management system for use in a business enterprise, comprising:
a database including multiple evacuation plans;
a plurality of communication channels capable of receiving at least one of the multiple evacuation plans; and
a logic device that receives information regarding the location of an emergency within the business enterprise;
wherein the logic device selects a customized evacuation plan from among the multiple evacuation plans.

2. The emergency management system of claim 1, wherein the customized evacuation plan is selected based on the location of the emergency and the location of the channel to which the customized plan is sent.

3. The emergency management system of claim 1, further comprising a sensor that generates weather related information.

4. The emergency management system of claim 3, wherein the customized plan is selected based on the weather related information.

5. The emergency management system of claim 1, wherein the evacuation plans are customized for each individual in the business enterprise.

6. The emergency management system of claim 1, wherein the customized evacuation plan is selected based on information regarding the release of hazardous material.

7. The emergency management system of claim 1, wherein the database includes predetermined potentially hazardous situations.

8. The emergency management system of claim 3, wherein the weather related information includes wind direction and speed.

9. The emergency management system of claim 2, wherein each channel in the plurality conveys a unique evacuation plan related to the hazardous conditions at that channel's location.

10. The emergency management system of claim 9, wherein the channel includes a pager that receives a custom evacuation plan and sends an acknowledgement back to the logic device.

11. The emergency management system of claim 1, wherein the evacuation plan selected is manually monitored by a user prior to being sent to one of the communication channels.

12. The emergency management system of claim 11, wherein the user amends the evacuation plan prior to sending the evacuation plan to one of the communication channels.

13. The emergency management system of claim 11, wherein the user defers delivery to the intended communication channel.

14. The emergency management system of claim 11, wherein the user replaces the evacuation plan that is to be sent.

15. The emergency management system of claim 12, further comprising a record of the user's actions regarding the evacuation plans.

16. The emergency management system of claim 7, wherein evacuation plans are prioritized by the hazardous situations.

17. An evacuation management system for use in a business enterprise, comprising:
a source of automatically generated information from the business enterprise;
a logic device capable of determining if predetermined events have occurred within the business enterprise based on the source of automatically generated information;
a plurality of communication channels, wherein at least one channel within the plurality receives a customized plan.

18. The evacuation management system of claim 17, wherein the customized plan is based on information contained within the source of automatically generated information.

19. The evacuation management system of claim 17, further comprising a source of human generated information, wherein the customized set of plans is based on information contained within the source of automatically generated information and the source of human generated information.

20. A method for use in an emergency population-status system, comprising:
gathering information regarding an emergency in a business enterprise from a plurality of information sources;
assessing the credibility of the information gathered; and
determining the probability of an individual's presence within the business enterprise.

21. The method of claim 20 further comprising, comparing at least two time measurements.

22. The method of claim 21 further comprising, comparing an event time and a report time.

23. The method of claim 21, wherein the time measurements are chosen from the group consisting of an event time, a report time, an incident time, and an analysis time.

24. The emergency management system of claim 21, wherein the credibility of the information gathered is adjusted based on an aging algorithm.

25. The emergency management system of claim 24, wherein the aging algorithm includes an exponential function.

26. The emergency management system of claim 24, wherein different pieces of gathered information are subject to different aging functions.

27. The method of claim 20, further comprising determining how direct the information gathered is to the actual source of the information.

28. The method of claim 20, wherein the information is gathered from an individual.

29. The method of claim 28, wherein assessing the credibility of the information gathered includes the who is individual reporting assessing the credibility of their own testimony.

30. The method of claim 20, wherein the information is gathered from an automated database.

31. The method of claim 30, wherein the automated database is coupled to a global positioning system (GPS).

32. The method of claim 20, wherein the information is gathered from the group consisting of a locator database, an employee database, a badging database, and an attendance database.

33. The method of claim 20, wherein the information is gathered from the group consisting of a personal computer (PC), a pocket PC, web applications, and an application running on a PC.

34. The method of claim 20 further comprising, adjusting the probability according to an aging factor.

35. The method of claim 34, wherein the adjusting the probability according to an aging factor further comprises comparing at least two time values.

36. The method of claim 20, further comprising determining a level of concurrence among the gathered information.

37. The method of claim 20, further comprising alerting an emergency responder as to the probability of an individual's presence.
